(19) United States
(12) Patent Application Publication
(10) Pub. No.: US 2023/0162191 A1
(43) Pub. Date: May 25, 2023

(54) REAL-TIME BIOMETRICS-ACTIVATED DOUBLE ENTRY AND INTERACTIVE ELECTRONIC LEDGER SYSTEM AND DEVICE

(71) Applicant: Renato Valencia, Muntinlupa City (PH)

(72) Inventor: Renato Valencia, Muntinlupa City (PH)

(21) Appl. No.: 17/531,781

(22) Filed: Nov. 21, 2021

(51) Int. Cl. G06Q 20/40; G06Q 20/10; G06Q 20/36

(52) U.S. Cl. CPC G06Q 20/40145; G06Q 20/108; G06Q 20/3678; G06Q 2220/00

(57) ABSTRACT

The present disclosure generally relates to an application program in an ICD on the user device that is actually a real-time, double entry, biometrics-activated interactive ledger system for payment and other transactions. The ePassbook is a digital cash payment system that would approximate or even be better than real cash payment in terms of efficiency, cost, convenience, security, and service. The ePassbook is a ledger system in the ICD on the user's device that shall enable the opening of prepaid accounts, make transactions, check credit cards, debit cards, and account balances, etc. on a user device, for example, a smartphone. The ePassbook allows a buyer to initiate a payment transaction upon selection of a payment method displayed on the first user device via the ledger A or, accept the payment by a receiver or a merchant via the second ledger/ledger B on the second user device. The ePassbook is a real-time biometrics-activated double-entry and interactive ledger system in the ICD on the user's device that is connected to and is part of a broader real time double entry and interactive general ledger system that resides in a server.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The present invention generally relates to an application program in an ICD on a user's device which is actually a real-time, biometrics-activated, double-entry interactive electronic ledger system (ePassbook) for prepaid account, current account, savings account, trust account, deposit account, and other accounts of banks and entities/issuers, which ledger is connected to and is part of a broader, real time, double entry interactive electronic general ledger system and involves digital cash or fiat, can pay and record purchases between parties as well transfer funds speedily, efficiently, safely, securely, more conveniently and smartly, as well as have balanced books to ensure not only accuracy but also avoid double spending or spending without any balance.

### BACKGROUND

Credit, debit and prepaid cards, as digital payment devices for purchases of goods and services from Merchants, were introduced in the fifties, sixties, and seventies and have spurred the growth of commerce around the world.

For efficiency, security and convenience, an ecosystem evolved amongst the Cardholder (or Subscriber), the Merchant, the Issuer and the Acquirer (mostly banks), with the Card Payment Networks (Visa, MasterCard, etc.) guaranteeing the integrity, efficiency, convenience and security of the system. Third party processors, gateways and tokenization companies further enhanced and strengthened the platform. Despite these developments, recent reports indicate about 2.5 billion people, or 30% of total world population, are still unbanked, mostly from developing countries. Moreover, 85% of global retail sales are estimated to be paid with cash or paper bills, and 15%, with digital cash. Thus, most still believe that “Cash is king,” and that cashless society remains elusive. Because the country bears the high costs of printing, distributing and securing cash, estimated at 0.5% to 1.5% of a country's GDP, consumers consider cash as free, convenient and anonymous, with a portion going to illegal or criminal activities. With the recent pandemic, most have become wary that cash presents an easy way of transmitting the disease.

Because of the huge infrastructure and related costs for pre-authorization, clearing, and settlement of digital payment transactions, mainly at the backend, processing costs have remained high (1% to 5% Merchant Discount Rate, or even higher), despite the advent of technology. While pre-authorization happens in seconds or thereabouts which quickly enables the purchase of goods and services, clearing and settlement take days or longer, especially for smaller merchants With this invention, Real time, Double Entry, Biometrics-Activated, and Interactive Ledger System (“ePassbook”), payments with fiat and other currencies for exchange of goods and services, can now be done and recorded real time, and books can be balanced at the physical or virtual Point of Sale (POS) to enable accurate payment anywhere, anytime, and any device. Thus, ePassbook can lay the foundation for achieving financial inclusion and cashless society.

Moreover, because a prepaid account, is first “loaded” with digital cash, it does not entail any credit risks and therefore deserves much lower fees compared to that of credit cards, debit cards, etc. under the traditional card payment network system. Likewise, debit cards do not entail credit risks and their balances may now be known real time, with the advent of 5G or faster communications.

With this invention, the Prepaid, Debit or any other Account can transact with another Prepaid, Debit or any other Account under one Centralized General Ledger System (one Trustee), or with another Account under another Centralized General Ledger System, or another Account with a Decentralized General Ledger System (two or more Trustees), or with another account under a combination of Centralized and Decentralized General Ledger Systems (Hybrid). With the advent of block-chain technology, payment and other transactions can become transparent and immutable. Hence, where for one unique transaction, transaction values may differ from different ledger systems, the Ledger Systems may agree to follow the value taken from blockchained transaction. The ePassbook does not need the pre-authorization, clearing and settlement processes with the exchange of goods and services and therefore does away with the high costs that go with the traditional card network payment system.

### SUMMARY

The present disclosure generally relates to an application program in the ICD on the user's device that is actually a real-time, biometrics-activated, double-entry interactive electronic ledger system (ePassbook) for prepaid account, current account, savings account, trust account, deposit account, and other accounts of banks and entities/issuers which ledger is connected to and is part of a broader general ledger system, and involves digital cash or fiat, can pay and record purchases between parties as well transfer funds speedily, efficiently, safely, securely, more conveniently and smartly, as well as with balanced books, ensure not only accuracy but also avoids double spending or spending without any balance.

In one embodiment, the ePassbook can be a digital cash payment system that can approximate or even be better than real cash payment in terms of efficiency, cost, convenience, security, and service.

In one embodiment, the ePassbook includes a ledger system for opening prepaid accounts, making transactions, checking credit cards, debit cards, and account balance, etc. In one embodiment, the ePassbook is configured to allow offline transactions where digital cash balance or guaranteed payment is available. In one embodiment, the ePassbook can be connected to and be part of a centralized, decentralized or hybrid broader, online, double entry general ledger system. In one embodiment, the ePassbook in a first user device and the ePassbook in a second user device are connected via the internet to a broader general ledger system that resides in a server. Although the server is shown as a single entity. In general, the server represents various cloud-based services capable of implementing the back-end portions of the invention. The first user device and the second user device are in communication with the general ledger system in the server via the Internet. The first user device and the second user device can be devices used by a buyer or subscriber A and a receiver or merchant or subscriber B, respectively. It is to be understood that although only two computing devices are shown, that the system can accommodate practically any number of computing devices or user devices. In one embodiment, the ePassbook can be connected to a centralized, decentralized or hybrid broader, online, double entry general ledger system in a server.

In one embodiment, the first user device can also be used by any subscriber for opening prepaid accounts, making transactions, checking credit cards, debit cards, and account balance, etc. through the general ledger system. Although the first user device and the second user device are drawn to resemble a smartphone, it is to be understood the first user device and the second user device can be, but not limited to, a smartphone, a laptop computer, a desktop computer, a tablet computer, a watch or other wearables, a Web-enabled television, and so forth.

In one embodiment, the first user device and the second user device are linked to the general ledger system in the server via a network/internet; wherein the first user device and the second user device include at least one processor coupled to a memory, and an on-board biometric sensor for capturing biometric data, wherein the memory stores a set of instructions and the processor is configured to execute the set of instruction to cause the first user device and second user device to perform operations comprising: facilitating, opening and managing of prepaid accounts by participating issuers, wherein the participating issuers activate the prepaid accounts only to the extent they have available cash, legal tender, or guarantee, personalizing the ePassbook in-person or offsite web/mobile application by embedding a ledger application program in an input capture device (ICD) on the first user device together with a reference identity (ID) with biometrics of a user, and also authenticating the user by the issuer upon selection of a payment method with the reference ID, thereby facilitating the user to activate the ePassbook when the captured biometrics match with the reference biometrics, allowing the buyer/user to check transactions associated with credit cards, debit cards, and account balance in the input capture device on the first user device, receiving a request from the first user device to initiate a funds transfer from its prepaid account to another prepaid account associated with the second user device, initiating a payment transaction upon selection of the payment method displayed on the first user device via the first ledger or ledger A, and accepting the payment by a receiver via a second ledger or ledger B on the second user device. The first ledger or ledger A and the second ledger or ledger B are connected to the broader double entry online general ledger system. In one embodiment, the ePassbook is further configured to provide real-time transactions and account balances.

In one embodiment, the reference ID with biometrics of the user in the ICD on the first user device are authenticated through the internet by the issuer from the server regularly, from time to time, or on demand. In one embodiment, the reference ID is at least any one of a national ID, voter's ID, social security ID, driver's license or other acceptable ID with biometrics, wherein the biometrics is at least any one a facial, voice, fingerprint, retina/iris recognition, etc.

In one embodiment, the ePassbook is configured to facilitate and record transactions and provide account balance and other information on real time or near real time and also enable real time payment to merchants and users or individuals by debiting and crediting ledgers. The ePassbook is further configured to ensure that initially issued or created digital cash or fiat balances with or is equal to re-issued digital cash, thereby preventing unauthorized re-issuance of digital cash or fiat balances, wherein the issued digital cash and re-issued digital cash include crypto currencies generally described as decentralized currencies.

In one embodiment, the ePassbook is further configured to use artificial intelligence (AI), big data, and other tools to provide services through the general ledger system, such as generating financial statements and reports, analytics, audit trail, etc. and to passbooks enhance the system. The ePassbook is further configured to automatically deactivate the ePassbook when dormant or with minimum or zero cash balance and activate for micropayments and mass transit payments. In one embodiment, the general ledger system is further configured to provide a balance sheet and other financial reports in real-time using mathematical reconciliation, wherein the balance sheet includes a statement of a book value of all of the assets and liabilities including equity and retained earnings of a company or other organization or person at a particular date and point in time. In one embodiment, the general ledger system processes double entry payment transactions or T accounts (Debit account A, Credit account B) that can be blockchained or not. In one embodiment, the transactions are device to device transactions, which include a card or a mobile to POS device, mobile to mobile, peer-to-peer, voice to device, and machine to machine. In one embodiment, the ePassbook is configured to allow offline transactions when digital cash balance or a guarantee in the user's prepaid account is available. In one embodiment, the general ledger system is further configured to automatically deactivate the ePassbook when dormant or with minimum or zero cash balance and activate for micropayments and mass transit payments. In one embodiment, the ePassbook is further configured to use artificial intelligence (AI), big data, and machine learning tools to provide services such as generating financial statements and reports, analytics, audit trail, etc. and to enhance the system.

In one embodiment, the ePassbook is further configured to transact with other electronic devices to include payment devices, appliances, wearables, card payment network or systems using at least any one of real or virtual payment cards, radio-frequency identification (RFID) cards, sticker and readers, near-field communication (NFC), beacon or similar technologies, quick response (QR) or similar codes, biometrics, PINs, passwords, SMSs, direct mobile billing, in-app payments, mobile or online commerce, pre-ordering, location-based services, loyalty or incentive programs, and GPS, ATMs, and point of sale (POS) devices.

In one embodiment, the first ledger or ledger A is resided in the ICD on the first user device of a subscriber A issued by the bank or the entity/issuer. The first ledger is loaded or replenished automatically or manually from other prepaid, debit, or other accounts or other accounts of the user with the issuer or other issuers/banks by the central ledger system, or through loading stations or devices. In one embodiment, the second ledger or ledger B is resided in the ICD on the second user device of the receiver or a subscriber B issued by a bank or an entity/issuer. In one embodiment, the payment method is at least any one of a real or virtual QR codes, or a similar code, real or virtual payment cards, passwords or PIN numbers, and biometric authentication. In one embodiment, the system is further configured to imitate the payment method by digital assistant to include Siri, Alexa, and other digital assistants, or by the central ledger system. The ePassbook is faster, cheaper, smarter, easier and safer for online or offline transactions. In one embodiment, the ePassbook through the general ledger system, may provide services such as reports, analytics, archives, audit trail, etc. using, but not limited to, artificial intelligence, big-data, quantum computing, 5G network, etc. In one embodiment, the ePassbook can be used for different applications such as, but not limited to, make payments to include bill payments, etc., buying/selling, inventory/receivables/other assets management, and transfer or remittance of funds, etc.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIGS. 1A-1C illustrate an example of an ePassbook i.e., a real-time biometrics-activated double entry and interactive general ledger system, according to an embodiment of the present invention.

FIG. 2 illustrates an example of a subsidiary ledger (ePassbook) for providing details related to financial transactions of an account and keeping records of the financial transactions in a prescribed format, according to an embodiment of the present invention.

FIG. 3 illustrates an example of a double entry payment transaction or T account (Debit prepaid account A and Credit prepaid account B) that goes to a general ledger system which then generates an enterprise Statement of Income, Balance Sheet and other reports, according to an embodiment of the present invention.

FIG. 4 illustrates an example of a ledger-to-ledger interaction (Ledger A with Ledger B), according to an embodiment of the present invention.

FIG. 5 illustrates an example of a ledger A and ledger B connected to a centralized, decentralized, or hybrid general ledgers, respectively, according to an embodiment of the present invention.

FIG. 6 illustrates an example of central banks issuing digital currencies to banks, and the banks, in turn, re-issuing the same, according to an embodiment of the present invention.

FIG. 7 illustrates an example of a first user device and second user device having a subsidiary ledger each for Cryptocurrency, Fiat Currency, and other currencies, according to an embodiment of the present invention.

FIG. 8 illustrates an example of a location and cross border of the first user device used by the subscriber A and the second user device used by the subscriber B, according to an embodiment of the present invention.

FIG. 9 illustrates a process for enabling real time payment to merchants and individuals by debiting and crediting ledgers, and user bank debit accounts replenishing the minimum balances of the user prepaid accounts with the issuer, according to one embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

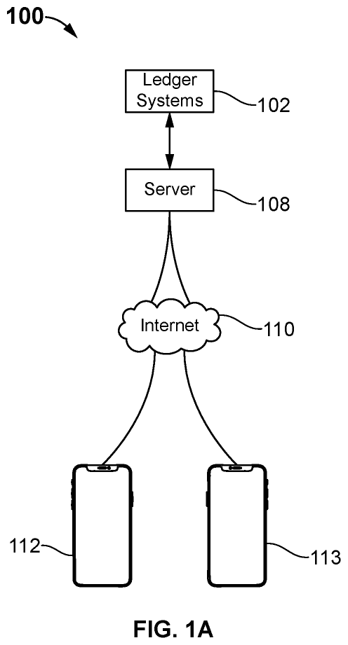

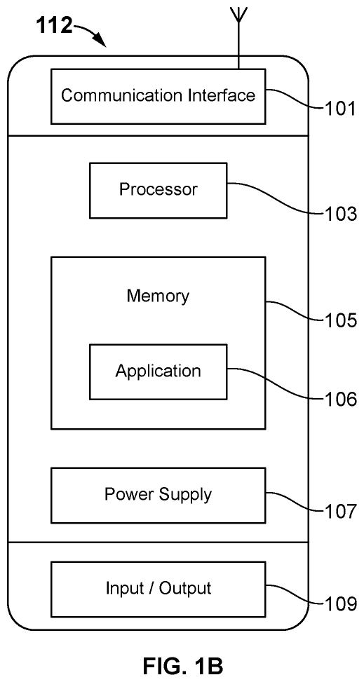

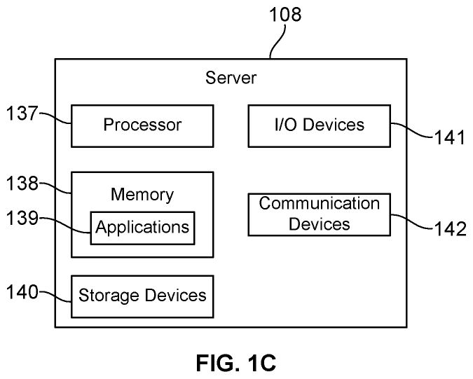

Referring to FIG. 1A, a block diagram of a real-time double entry and interactive electronic general ledger system 100 (ePassbook), according to an embodiment is illustrated. As will be described in greater detail, the system 100 can be a digital cash payment system that can approximate or even be better than real cash payment in terms of efficiency, cost, convenience, security, and service. In one embodiment, the system 100 is provided for prepaid account, current account, savings account, trust account, deposit account, and other accounts of banks and enterprises involving digital cash or fiat, can pay and record purchases between parties, as well transfer funds speedily, efficiently, safely, securely, more conveniently and smartly, as well as balance the books that ensures not only accuracy but also avoids double spending or spending without any balance.

In one embodiment, the ePassbook 100 includes a general ledger system 102 for opening prepaid accounts, making transactions, checking credit cards, debit cards, and account balance, etc. In one embodiment, the ePassbook is configured to allow offline transactions where digital cash balance or guarantee is available. In one embodiment, the ePassbook 100 can be a centralized broader double entry online general ledger system, a decentralized general ledger system or a hybrid general ledger system (centralized and decentralized). In one embodiment, the system 100 includes a server 108 and a first user device 112 and a second user device 113, which are connected to the server 108 via the Internet 110. Although the server 108 is shown as a single entity. In general, the server 108 represents various cloud-based services capable of implementing the back-end portions of the invention. The first user device 112 and the second user device 113 are in communication with the server 108 via the Internet 110. The first user device 112 and the second user device 113 are devices that can be used by a buyer or subscriber A and a receiver or a merchant or a subscriber B, respectively. It is to be understood that although only two computing devices 112 and 113 are shown, that the system 100 can accommodate practically any number of computing devices or user devices.

FIG. 1B shows a block diagram of a typical first user device 112 useable in conjunction with the system 100 for making payment transactions. In one embodiment, the first user device 112 can also be used by any subscriber for opening prepaid accounts, making transactions, checking credit cards, debit cards, and account balance, etc. through the general ledger system 102. Although the first user device 112 and the second user device 113 are drawn to resemble a smartphone, it is to be understood the first user device 112 and the second user device 113 can be, but not limited to, a smartphone, a laptop computer, a desktop computer, a tablet computer, a watch or any wearable, a Web-enabled television, and so forth.

As depicted, the first and second user devices 112 and 113 include a communication interface 101, a processor 103, a memory 105, a power supply 107, and input/output 109. In an embodiment, the communication interface 101 controls various input/output devices including a fingerprint sensor, a digital camera, a connector port, a headphone jack, and a built-in speaker, and microphone. In various embodiments, the communication interface 101 can also include a touchscreen. The processor 103 includes a central processing unit (CPU). The memory 105 can include ROM/RAM, flash memory and the like. The power supply 109 can include a re-chargeable battery and a power charger. Application 106 is stored in the memory 105, and includes program code non-transitorily embedded thereon. This program code includes various programs executable by the processor 103 to interface with the server 108, record video/audio, process text, encrypt data, and so forth. In general, the application 106 will include the software for the “client-side” methods described herein. These client-side methods will allow users to interface with the general ledger system 102 via the server 108.

FIG. 1C shows a block diagram of a typical computing system useable as the back-end server 108. The server 108 is programmed in accordance with the “server-side” methods described herein. The server 108 comprises a computer processor 137, memory (RAM, ROM, etc.) 138 (including memory for non-transitorily storing program code comprising applications 139), fixed and removable storage devices 140 for example, hard drive, memory stick, solid state drives, etc., input/output devices 141, for example, keyboards, display monitors, pointing devices, printers, etc., and communication devices 142, for example, Ethernet cards, Wi-Fi cards, modems, etc. Although the Internet 110 is depicted as being used for communication among the illustrated entities, it is to be understood that other network elements could, alternatively, or in addition, be used. These can include any combination of proximity, medium range, long range communications, TV/radio broadcasting, wi-fi; satellite, wLAN, Bluetooth®, wide area networks, local area networks, public switched telephone networks, wireless or wired networks, intranets, or any other communication system.

The system 100 includes an application (106, 139) which enables an issuer to transact, through the server 108, with a plurality of user devices. Under this arrangement, a request-response protocol, such as hypertext protocol (HTTP), can be employed such that the user (first user device 112) can initiate requests for services from the server 108 and the server 108 can respond to each respective request by, for example, executing an application, and (where appropriate) sending results to the client via the first user device 112. The server 108 can also include a database and a logic engine operatively linked to the server, allowing the application to query and store data therein. It is to be understood that in some embodiments, however, substantial portions of the application logic can be performed on the client using, for example, the AJAX (Asynchronous JavaScript and XML) paradigm to create an asynchronous web application. Furthermore, some portions of the application logic can be performed using a browser extension. Moreover, it is to be understood that in some embodiments the application can be distributed among a plurality of different servers (not shown).

In the following description of the present invention, exemplary methods for performing various aspects of the present invention are disclosed. It is to be understood that the steps illustrated herein can be performed by executing computer program code written in a variety of suitable programming languages, such as C, C++, C#, Visual Basic, and Java. It is also to be understood that the software of the invention will preferably further include various Web-based applications that can be written in HTML, PHP, JavaScript, jQuery, etc., accessible by the clients using computing devices 112 through a suitable browser 145, for example, Internet Explorer, Microsoft Edge, Mozilla Firefox, Google Chrome, Safari, Opera or as an application running on a suitable mobile device, for example, an iOS or Android “app”.

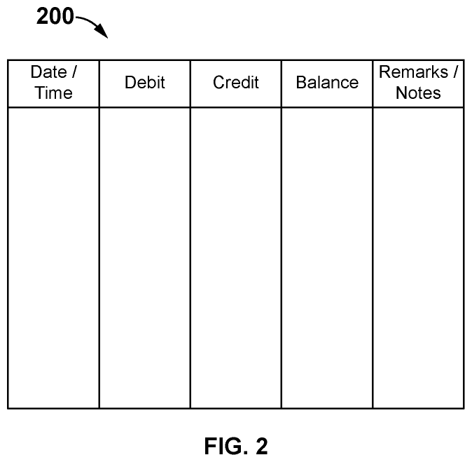

FIG. 2, shows a subsidiary ledger 200 (ePassbook) for providing details related to financial transactions of say, a prepaid account, and keeping records of the financial transactions in a prescribed format. The subsidiary ledger 200 provides the details that make up the balance of specific ledger account. The ledger account provide an ending balance for each particular account. The ledger 200 can be a subsidiary ledger, which is used to provide the details that result in that ledger balance. The ledger 200 also provides the details about date/time, debit and credit cards, balance, remarks/notes, etc.

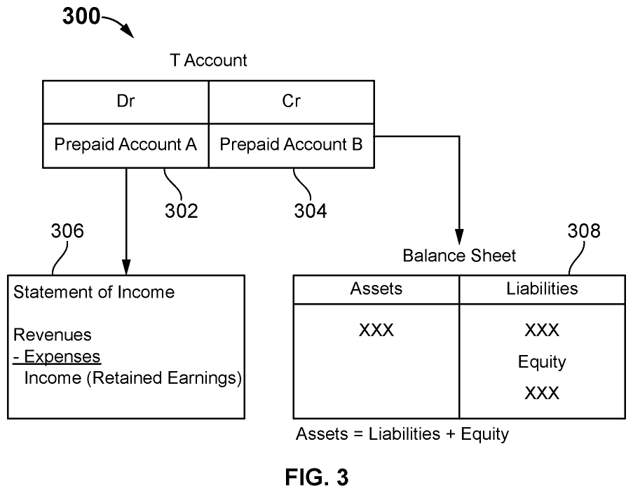

FIG. 3 shows a double entry payment transaction or T account (Debit prepaid account A, Credit prepaid account B) 300 going to a broader double entry online general ledger system 102 (shown in FIG. 1A). The general ledger system 102 can then generate an enterprise Statement of Income 306 and Balance Sheet 308 in real-time. In one embodiment, the double entry online general ledger system 102 is further configured to provide other financial reports in real-time using mathematical reconciliation. The balance sheet includes a statement of a book value of all of the assets and liabilities including equity and retained earnings of a company or other organization or a person at a particular date and point in time. The double entry general ledger system 102 records business transactions of the prepaid accounts based on a set of rules formulated for recording financial transactions of the prepaid accounts. In this double entry general ledger system 102, every transaction has two impacts i.e., Debit (expenses) and Credit (income). The rule states that for every debit, there is a credit and for every credit, there is a debit. It is based on the formula “Assets=Liabilities+Equity (Capital) plus Retained Earnings.

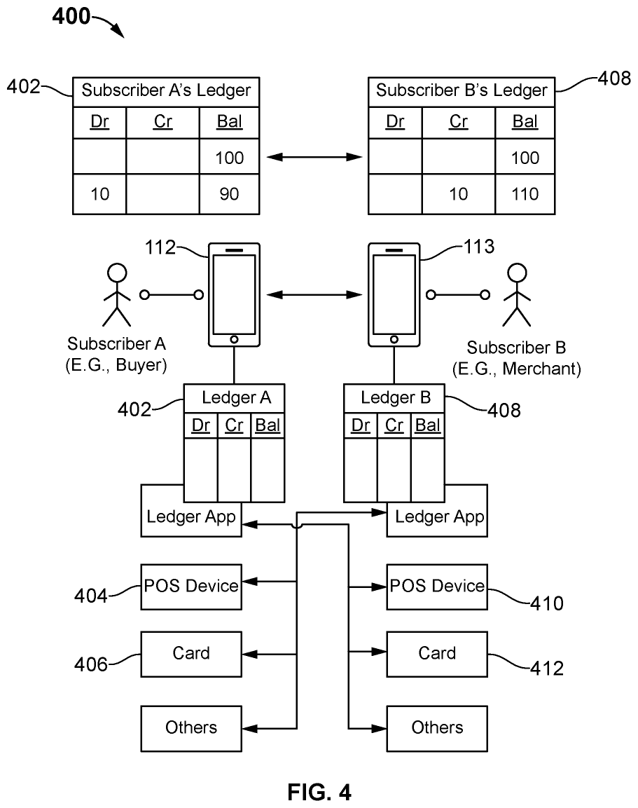

FIG. 4, shows a ledger-to-ledger interaction 400 according to the present invention is disclosed. The ledger-to-ledger interaction 400 enables the buyer to check transactions associated with credit cards, debit cards, and account balance in an input capture device (ICD) on the first user device 112, for example, a smartphone. The first user device 112 used by the buyer or a subscriber A is configured to connect to a first ledger or a ledger A 402 (ePassbook A) through a ledger application. The first user device 112 can be used by the buyer. The buyer can connect and access bank accounts, credit cards, debit cards, and account balance through the ledger A 402 (ePassbook A). The second user device 113, for example, a POS device used by a subscriber B or a merchant is configured to connect to a second ledger or a ledger B 408 (ePassbook B) through a ledger application. The merchant can connect and access bank accounts, credit cards, debit cards, and account balance through the ledger B 408.

In one embodiment, the ledger A or first ledger 402 is resided in the ICD on the first user device 112 of the subscriber A issued by the bank or by the entity/issuer. In one embodiment, the ledger A 402 is loaded or replenished automatically or manually from other prepaid or other accounts of the user with the issuer or other issuers by the central ledger system, or through loading stations or devices. In one embodiment, the ledger B or second ledger 408 is resided in the ICD on the second user device 113 of the subscriber B issued by the bank or the entity/issuer.

In one embodiment, the ledger A 402 (ePassbook A) and ledger B 408 (ePassbook B) can allow and receive the transactions, which are device-to-device transactions. In one embodiment, the device-to-device transactions include, but not limited to, card or mobile to a POS device, mobile to mobile, peer-to-peer, voice to device, and machine to machine, etc. In one embodiment, a POS device or point of sale machine 404, credit and debit cards 406, and others of the buyer are connected to the ledger B 408. In one embodiment, the POS device 410, credit and debit cards 412, and others of the merchant are connected to the ledger A 402. The ledger A 402 and ledger B 408 can provide details of the transactions associated with debit and credit amounts and account balance of the buyer and merchant, respectively.

In one embodiment, the first user device 112 and the second user device 113 can perform operations comprising: facilitating opening and managing of prepaid accounts by user with participating issuers, wherein the participating issuers activate the prepaid accounts only to the extent they have available cash, legal tender, or guarantee to activate ePassbook; personalizing in-person or offsite web/mobile application by the ePassbook by embedding a ledger application program in an input capture device (ICD) on the first user device 112 together with a reference identity (ID) with biometrics of a user, and also authenticating the user by the issuer upon selection of a payment method with the reference ID, thereby facilitating the user to activate the ePassbook when the captured biometrics match with the reference biometrics, allowing the buyer/user to check transactions associated with credit cards, debit cards, and account balance in the input capture device on the first user device 112; receiving a request from the first user device 112 to initiate a funds transfer from its account to another account associated with the second user device 113; initiating a payment transaction upon selection of the payment method displayed on the first user device 112 via the first ledger or ledger A 402, and accepting the payment by a receiver via the second ledger 408 on the second user device 113. The first ledger or ledger A 402 (ePassbook A) and the second ledger or ledger B 408 (ePassbook B) are connected to the ePassbook i.e., the broader double entry online general ledger system. In one embodiment, the ePassbook 100 is further configured to provide an electronic passbook (ePassbook) for the user through the ledger application program in the input capture device of the first user device 112, wherein the ePassbook provides real-time transactions and account balances.

In one embodiment, the reference ID with biometrics of the user in the ICD on the first user device are authenticated through the internet by the issuer from the server regularly, from time to time, or on demand. In one embodiment, the reference ID is at least any one of a national ID, voter's ID, social security ID, driver's license or other acceptable ID with biometrics, wherein the biometrics is at least any one a facial recognition, voice recognition, fingerprint recognition, and retina/iris recognition.

Prepaid Accounts shall be opened in and managed by participating Issuers (banks, payment networks, and EMIs) as may be authorized by the central bank of a country. Issuers can activate prepaid accounts only to the extent they have available cash, legal tender, or guarantee; any amount issued beyond such level shall be considered by the central bank as unauthorized. Each issuer shall maintain the books of its prepaid accounts. The total digital cash issued to prepaid accounts by an Issuer should always balance with the Issuer's equivalent cash or legal tender balance on real time or near real time.

In one embodiment, the ePassbook for the use of the prepaid accounts in a closed loop payment system (proprietary) or open loop payment system (multi-issuers) shall be maintained by the Issuer, or group of Issuers, or a network company under an agreed set of rules and protocols. In one embodiment, the ePassbook can be centralized, decentralized or hybrid as may be agreed upon by the participants. Since the currency used is digitized legal tender, the transaction shall be done and recorded using double entries under accepted accounting principles (for example, debit the account of buyer, credit the account of the seller).

In one embodiment, the ledger A 402 and ledger B 408 can be used one time (like gift cards or certificates) or multiple times like a reloadable wallet. The ledger A 402 pays and records transactions and provides account balance and other information on real time or near real time. The ledger A 402 and ledger B 408 can be used anytime, anywhere, any device. It can use fiat in any currency (US dollar, Euro, etc.), generally described as centralized currency, or cryptocurrencies, generally described as decentralized currencies, as means of payment. The transaction limits can be prescribed for cash balance, maximum spend per day or per cycle period (weekly, monthly, etc.), per item, etc. In one embodiment, the ledger A 402 and ledger B 408 can be used locally or across national borders. In one embodiment, the ledger A 402 and ledger B 408 can be part of a closed loop payment system (proprietary) or open loop payment system (multi-issuers). It can handle financial or non-financial transactions (voting; documents; etc.). All entries in the ledgers A and B can be encrypted or decrypted. In one embodiment, the ledger A 402 and ledger B 408 enable proximity, medium range, and long-range communications. The ePassbook books are always balanced real time (ex. debits=credits; cash balances, etc.) to avoid mistakes, especially double spend or spending without balance.

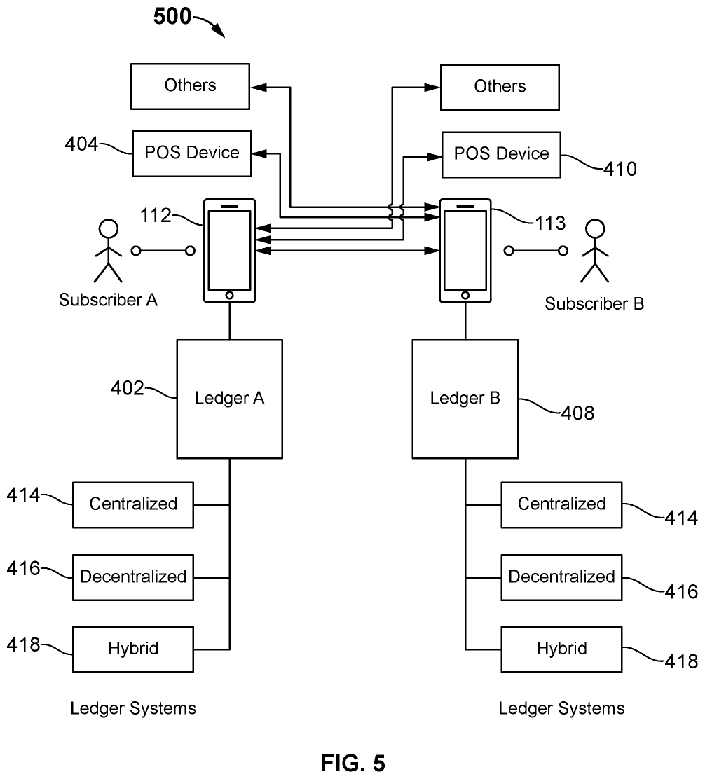

FIG. 5, shows the ledger A 402 and ledger B 408 connected to a general ledger system that is operated as centralized (one trustee), decentralized (multi-trustees), or hybrid ledgers (414, 416, and 418), respectively. The ledger A 402 and ledger B 408 can enable and record payments, buy-sell deals or move assets or property, etc.

In one embodiment, the ePassbook i.e., broader centralized,-decentralized or hybrid general ledger system is configured to enable and record transactions and also provide account balance and other information on real time or near real time. In one embodiment, the ePassbook is further configured to ensure what is initially issued or created as digital cash or fiat shall always balance with or equal to what digital cash is subsequently re-issued by the issuers, thereby preventing unauthorized issuance of digital cash or fiat and this balanced books requirement also applies to crypto currencies. In one embodiment, the ePassbook is further configured to use artificial intelligence (AI), big data, and other tools to provide services such as generating financial statements and reports, analytics, audit trail, etc. and to enhance the system.

In one embodiment, the ePassbook is further configured to automatically deactivate an ePassbook when dormant or with minimum or zero cash balance and activate for micropayments and mass transit payments. In one embodiment, the ePassbook allows transactions between device to device (card or mobile to POS device); mobile to mobile/peer-to-peer, voice to device, and machine to machine, etc.

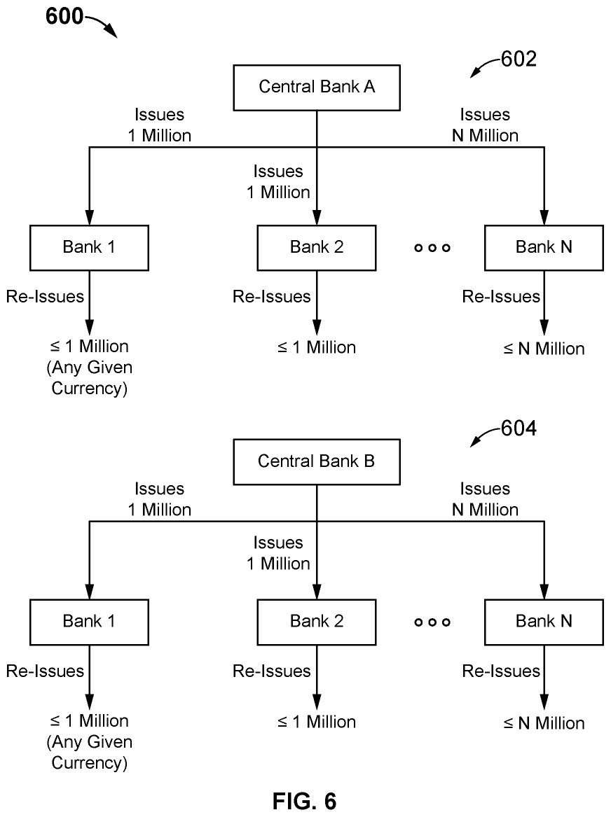

FIG. 6, shows central banks 602 and 604 issuing digital currencies in batches and with serial numbers to banks which, in turn, re-issue the same to their customers. A ledger balance is computed by banks at the end of each business day and includes all withdrawals and deposits to calculate the total amount of money in the account. The ledger balance is the opening balance in the bank account the next morning and remains the same all day.

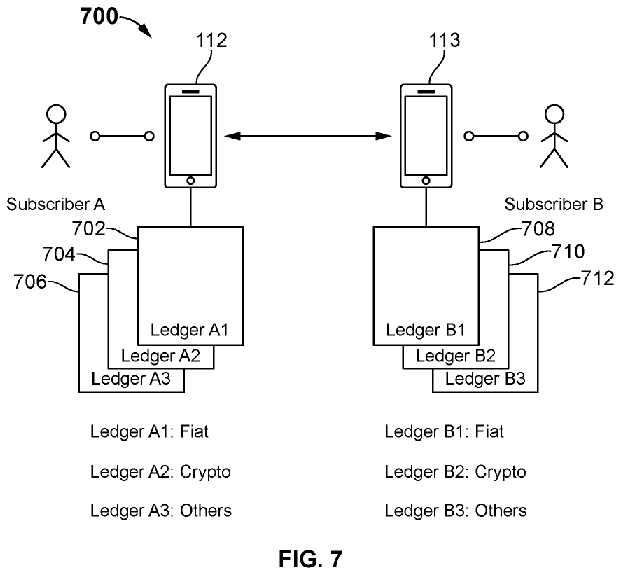

FIG. 7, the first user device 112 and the second user device 113 have a subsidiary ledger each for Cryptocurrency, Fiat Currency, and others currencies. In one embodiment, the first user device 112 used by the subscriber A has subsidiary ledgers A1 702, ledger A2 704, and ledger A3 706 for Cryptocurrency, Fiat Currency, and others currencies, respectively. The second user device 113 used by the subscriber B has subsidiary ledgers B1 708, ledger B2 710, and ledger B3 712 for Cryptocurrency, Fiat Currency, and other currencies, respectively.

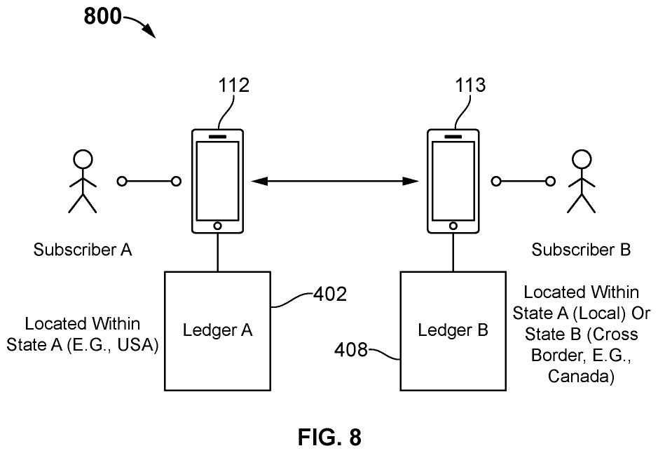

FIG. 8, shows a location and cross border of the first user device 112 used by the subscriber A and the second user device 113 used by the subscriber B. The first user device 112 connected to the ledger A 402 allows the subscriber A to make transactions and send amount to the subscriber B from anywhere and anytime. For example, subscriber A located within the state A, USA transacting with, for example, subscriber B located within the state A or state B (cross border, for example, Canada).

In one embodiment, the ePassbook 100 is further configured to imitate the payment method by digital assistant including Siri, Alexa, and other digital assistants, or by the general ledger system. In one embodiment, the payment method is at least any one of, but not limited to, a real or virtual QR codes, or a similar code, real or virtual payment cards, passwords or PIN or PW numbers, and biometric, voice, face, fingerprint authentications.

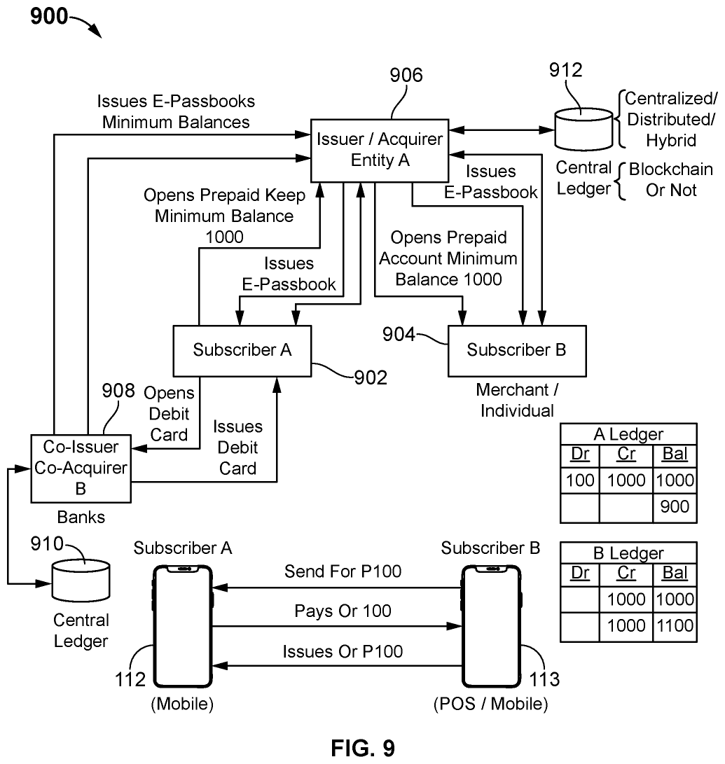

FIG. 9, illustrates a process for enabling real time payment to merchants and individuals by debiting and crediting ledgers according to one embodiment is disclosed. At one step, the user or subscriber A 902 can open a prepaid account by depositing minimum balance in the account, wherein the prepaid account is opened by an issuer/entity A 906. At another step, the ePassbook can issue an ePassbook to user 902. At another step, the merchant/individual or a subscriber B 904 can also open a prepaid account by depositing minimum balance in the account, wherein the prepaid account is opened by the issuer entity A 906. Further at another step, the ePassbook can issue an ePassbook to the merchant/individual or a subscriber B 904.

At another step, the user can open a debit card from the co-issuer B/banks 908 as source of replenishment of minimum balance for the prepaid account. At another step, co-issuer B 908 can issue the debit card to the user. At another step, the user or subscriber A can pay or transfer the amount from its prepaid account using the first user device 112 to the prepaid account associated with the subscriber B or the merchant by debiting and crediting ledgers. Further at another step, the subscriber B can issue a price on application (POA) or pricing details to the subscriber A.

In one embodiment, the issuer entity A 906 is connected to the central ledger 912 and the co-issuer B 908 is connected to the general ledger 910. In one embodiment, the co-issuer B 908 can replenish the minimum balances of respective prepaid accounts of the subscriber A with the issuer/entity A 906. In one embodiment, the ePassbook is configured to provide ePassbooks for the user and merchants/individuals through the ledger application program in the input capture device of the first user device 112 and second user device 113, respectively. The ePassbooks can provide real-time transactions and account balances. In one embodiment, the ePassbook is controlled by the owner of the asset in the ledger; the bank's general ledger merely executes the instruction of the account owner. In one embodiment, the ePassbook is both a payment and recording device.

The advantages of the present invention include: the participants of the ePassbook Payment System shall no longer need Acquirers (direct transactions between Issuers and merchants, tokenization (with the use of biometrics), and third-party processors or gateways (replaced by the ledger system). The ePassbook allows immediate payments, settlements, and records transactions. The ePassbook does not require authorization, clearing and settlement among the network participants; just ledger entries. Digital infrastructure for this payment is already in place and the cost of digital capacity increases shall be nowhere near that of existing physical infrastructures for payments; hence, transaction costs should dramatically go down. Since the smartphone is the point of sale, it could also be accessible to the billions of people presently unbanked. Ledger books must balance real time or near real time. The ePassbook can be operated by one issuer or as many groups of issuers willing to guaranty the ledger payment and recording system. This payment system shall be faster, cheaper, safer, smarter, and more inclusive. In one embodiment, the ePassbook can enhance services such as reports, analytics, archives, audit trail, etc. using, but not limited to, artificial intelligence, big-data, quantum computing, 5G network, etc. In one embodiment, the ePassbook can be used for different applications such as, but not limited to, making payments including bills payments, etc., buying/selling, inventory/receivables/other assets management, and transfer or remittance of funds, etc. In one embodiment, the ePassbook can be used one time (like gift cards or certificates) or multiple times like a reloadable wallet.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An application program (ePassbook) in an ICD on the user's payment and receiving device that is actually a real-time, biometrics-activated, double entry and interactive electronic ledger system that enables and records payment for a prepaid account of a bank or entity, wherein the ledger is connected to and is part of a broader electronic general ledger system residing in a server.

2. The ePassbook of claim 1, wherein the payment device, the first ledger (ePassbook A), is resided in the ICD on the first user device issued by a bank or entity/issuer, and is connected to and is part of a broader, electronic general ledger system.

3. The ePassbook of claim 1, wherein the receiving device, the second ledger (ePassbook B), is resided in the ICD on the second user device issued by a bank or entity/issuer, and is connected to and is part of a broader electronic general ledger system.

4. The ePassbook of claim 1, wherein the issuer personalizes the ePassbook in-person or through offsite web/mobile application by embedding the ePassbook in an input capture device (ICD) on the user's device, together with a reference ID with biometrics and biometrics matching application program, whereinafter the issuer vets the user, the issuer activates the ePassbook when: (a) the user is authenticated, i.e., the user's freshly captured biometrics matches the reference biometrics, and (b) the minimum balance is deposited in the user's prepaid account or payment is guaranteed by an acceptable third party.

5. The ePassbook of claim 1, wherein the reference ID with biometrics of the user in the ICD of the device is authenticated through the internet by the issuer from the server regularly, from time to time or on demand.

6. The ePassbook of claim 1, wherein in real time, the buyer's ePassbook transacts with the seller's ePassbook, the payer's ePassbook transacts with payee's ePassbook, the first user's ePassbook transacts with second user's ePassbook, said transactions cover, among others, any of the following:
a. facilitating opening and managing of prepaid accounts with minimum balance by participating issuers, wherein the participating issuers activate the prepaid accounts only to the extent they have available cash, legal tender or guaranteed payments;
b. allowing the user to check transactions and account balances associated with user credit cards, debit cards, and other payment devices in the ICD on the user's device;
c. receiving a request from the first user device to initiate a funds transfer from its prepaid account to another prepaid account associated with the second user device;
d. initiating a payment transaction via a first ledger on the first user device;
e. accepting the payment transaction by a receiver via a second ledger on the second user device,
f. providing real time transactions, account balances and other information.

7. The ePassbook of claim 1, wherein the reference ID is at least any one of a national ID, voter's ID, social security ID, driver's license or other acceptable ID with biometrics, wherein the biometrics is at least any one a facial, voice, fingerprint, or retina/iris recognition.

8. The ePassbook of claim 1, wherein the ePassbook is connected to and is part of a broader, real time, double entry centralized, decentralized, or hybrid (combination centralized and decentralized) electronic general ledger system.

9. The ePassbook of claim 1, is configured to enable and record payment and other transactions, provide account balance and other information in real time or near real time, or-anytime, anywhere, any device, and also enable real time payment to merchants and users or individuals by debiting and crediting ledgers, whether such payment is one-time (like gift certificate) or multiple times (like a reloadable ewallet).

10. The ePassbook of claim 1, is further configured to ensure that initially issued or created digital cash or fiat balances real time with or is equal re-issued digital cash, thereby preventing unauthorized issuance of digital cash or fiat balances, wherein the issued digital cash and re-issued digital cash include crypto-currencies.

11. The ePassbook of claim 1, is further configured to use artificial intelligence (AI), big data, machine learning and other tools and application programs to provide services, such as generating financial statements (Balance Sheet, Statement of Income) and reports, analytics, or audit trail, and to enhance the system.

12. The ePassbook of claim 1, is further configured to automatically deactivate when dormant or with minimum or zero cash balance and activate for micropayments and mass transit payments.

13. The ePassbook of claim 1, is further configured to provide a balance sheet and other financial reports in real-time using mathematical reconciliation, wherein the balance sheet includes a statement of a book value of all of the assets and liabilities including equity and retained earnings of a company or other organization or person at a particular date and point in time.

14. The ePassbook of claim 1, wherein the double entry transactions or T accounts (Debit account A, Credit account B) are blockchained or not blockchained.

15. The ePassbook of claim 1, is further configured to allow transactions with other electronic devices to include payment devices, appliances, wearables, card payment network or systems using at least any one of real or virtual payment cards, radio-frequency identification (RFID) cards, sticker and readers, near-field communication (NFC), beacon or similar technologies, quick response (QR) or similar codes, biometrics, PINs, passwords, SMSs, direct mobile billing, in-app payments, mobile or online commerce, pre-ordering, location-based services, loyalty or incentive programs, and GPS, ATMs, and point of sale (POS) devices.

16. The ePassbook of claim 1, wherein the transactions are device-to-device transactions, wherein the device-to-device transactions include a card or a mobile to a POS device, mobile to mobile, peer-to-peer, voice to device, and machine to machine, and wherein the transaction limits are prescribed for cash balance, maximum spend per day or per cycle period.

17. The ePassbook of claim 1, wherein the ePassbook is further configured to facilitate offline transactions under certain conditions, such as when digital cash balance is available.

18. The ePassbook of claim 1, wherein the ledger is loaded or replenished automatically or manually from another prepaid or other accounts of the user with the issuer or other issuers by the central ledger system, or through loading stations or devices.

19. The ePassbook of claim 1, wherein the broader double entry online general ledger system is resided in at least anyone of a public server, a private server, or hybrid cloud-based systems, wherein the broader double entry online general ledger system uses a proximity, medium range or long-range communications.

20. The ePassbook of claim 1, wherein the payment method is at least any one of a real or virtual QR codes, or a similar code, real or virtual payment cards, passwords or PIN numbers, RFID, NFC, or biometric authentication.

21. The ePassbook of claim 1, is further configured to imitate the payment method by digital assistant to includes Siri, Alexa, and other digital assistants, or by the central ledger system.

22. The ePassbook of claim 1, wherein the first and second user devices are at least any one of a smartphone, a laptop, a computer, a tablet, a mobile phone, a watch or any wearable, or other suitable mobile and/or handheld electronic devices.

23. The ePassbook of claim 1, wherein the network is at least any one of Wi-Fi, a cellular network, a wireless local area network (WLAN), or a radio communication.

23. The ePassbook of claim 1, is further configured to enable financial and/or non-financial transactions, wherein the non-financial transactions include voting, or contracts/documents, gaming.

24. The ePassbook of claim 1, is further configured to allow local transactions and/or across national borders.

25. The ePassbook of claim 1, is further configured to ledgers (ePassbooks) for prepaid accounts, deposit accounts, trust accounts, and other asset accounts of the bank or entity/issuer.

26. The ePassbook of claim 1, wherein the ePassbook transact with a closed loop payment system (proprietary) or an open loop payment system (non-proprietary/multi-issuers).

27. The ePassbook of claim 1, wherein the ePassbook uses cybersecurity application programs and tools, such as encryption/decryption, firewall, or anti-virus, to protect the system from cybercrimes and other threats.

28. The ePassbook of claim 1, wherein the books of the electronic general ledger system are always balanced in real time or regularly like every hour/12 hours/24 hours, weekly, monthly, quarterly, following the formula, “Assets=Liabilities plus Equity plus Retained Earnings,” to ensure accuracy, avoid double spending or spending without balance, as well as to prevent frauds.

29. The ePassbook of claim 1, uses fiat in any currency (US dollar, Euro) generally described as centralized currency, or cryptocurrencies, generally described as decentralized currency, as means of payment or store of value.
